(19) United States
(12) Patent Application Publication
(10) Pub. No.: US 2022/0369605 A1
(43) Pub. Date: Nov. 24, 2022

(54) VARIABLE BUOYANCY PLATFORM FOR AQUACULTURE FARMING

(71) Applicant: 723148 NB Inc., Richibuctou-Village (CA)

(72) Inventor: Danny KING, Richibuctou-Village (CA)

(21) Appl. No.: 17/746,536

(22) Filed: May 17, 2022

(30) Foreign Application Priority Data
May 20, 2021 (CA) 3119272

(51) Int. Cl. A01K 61/60; A01K 61/54

(52) U.S. Cl. CPC A01K 61/60; A01K 61/54

(57) ABSTRACT

A variable buoyancy platform including a support frame with a platform floor mounted to a top thereof. A plurality of bottom variable buoyancy tanks are disposed below the support frame and mounted thereto. Each bottom variable buoyancy tank includes an opening disposed in a bottom portion thereof and an air conduit port disposed in a top portion thereof. At least two side variable buoyancy tanks are disposed at opposite sides of the support frame and pivotally movable mounted thereto. Each side variable buoyancy tank includes an opening disposed in a bottom portion thereof and an air conduit port disposed in a top portion thereof. A bottom air conduit system is connected to the air conduit port of each bottom variable buoyancy tank. The bottom air conduit system is adapted for controllably providing air to each bottom variable buoyancy tank and for controllably releasing air from each bottom variable buoyancy tank. A side air conduit system is connected to the air conduit port of each side variable buoyancy tank. The side air conduit system is adapted for controllably providing air to each side variable buoyancy tank and for controllably releasing air from each side variable buoyancy tank.

This application claims priority to Canadian Patent Application No. 3,119,272 entitled Variable Buoyancy Platform For Aquaculture Farming filed on May 20, 2021, the entire contents of which are hereby incorporated by reference.

### FIELD

The present invention relates to aquaculture farming equipment, and more particularly to a variable buoyancy platform that enables simple adjustment of the level of the platform floor with respect to the surrounding water level.

### BACKGROUND

In present-day oyster farming oysters are contained in bags placed in shallow waters on the seafloor in close proximity to the surface or in floating bags/cages. During the growing season between spring and autumn the bags/cages need to be flipped in the water several times to prevent or remove fouling. The bags/cages are flipped manually resulting in an extremely labor intensive and time-consuming task.

In colder climate zones the bags/cages need to be placed in deeper waters to a depth below the depth of the ice before the winter season and raised again in early spring. Typically, the bags/cages are manually lowered by divers, raised using mechanical equipment such as winches. As is evident the lowering/rising of the bags/cages is also extremely labor intensive and time consuming.

The location of the bags/cages in shallow coastal waters exposes the same to the full forces of storms potentially resulting in substantial damage to or even complete loss of the bags and their contents, since the process of moving the same out of harm's way is too time consuming.

It may be desirable to provide a variable buoyancy platform that enables simple adjustment of the level of the platform floor with respect to the surrounding water level.

It also may be desirable to provide a variable buoyancy platform that enables simple adjustment of the level of the platform floor with respect to the surrounding water level such that the platform floor is above the water level and, in another mode of operation, below the water level in close proximity thereto.

It also may be desirable to provide a variable buoyancy platform that enables simple adjustment of the level of the platform floor with respect to the surrounding water level such that the platform floor is below the water level at a greater depth.

It also may be desirable to provide a variable buoyancy platform that enables lowering of the platform to a greater depth that is sufficiently fast for lowering the platform before an incoming storm.

### SUMMARY

Accordingly, in one case one object is to provide a variable buoyancy platform that enables simple adjustment of the level of the platform floor with respect to the surrounding water level.

In another case another object is to provide a variable buoyancy platform that enables simple adjustment of the level of the platform floor with respect to the surrounding water level such that the platform floor is above the water level and, in another mode of operation, below the water level in close proximity thereto.

In another case another object is to provide a variable buoyancy platform that enables simple adjustment of the level of the platform floor with respect to the surrounding water level such that the platform floor is below the water level at a greater depth.

In another case another object is to provide a variable buoyancy platform that enables lowering of the platform to a greater depth that is sufficiently fast for lowering the platform before an incoming storm.

According to one aspect, there is provided a variable buoyancy platform. The variable buoyancy platform comprises a support frame with a platform floor mounted to a top thereof. A plurality of bottom variable buoyancy tanks are disposed below the support frame and mounted thereto. Each bottom variable buoyancy tank comprises an opening disposed in a bottom portion thereof and an air conduit port disposed in a top portion thereof. At least two side variable buoyancy tanks are disposed at opposite sides of the support frame and pivotally movable mounted thereto. Each side variable buoyancy tank comprises an opening disposed in a bottom portion thereof and an air conduit port disposed in a top portion thereof. A bottom air conduit system is connected to the air conduit port of each bottom variable buoyancy tank. The bottom air conduit system is adapted for controllably providing air to each bottom variable buoyancy tank and for controllably releasing air from each bottom variable buoyancy tank. A side air conduit system is connected to the air conduit port of each side variable buoyancy tank. The side air conduit system is adapted for controllably providing air to each side variable buoyancy tank and for controllably releasing air from each side variable buoyancy tank.

According to an aspect, there is provided a variable buoyancy platform. The variable buoyancy platform comprises a support frame with a platform floor mounted to a top thereof. A plurality of bottom variable buoyancy tanks are disposed below the support frame and mounted thereto. Each bottom variable buoyancy tank comprises an opening disposed in a bottom portion thereof and an air conduit port disposed in a top portion thereof. At least two side variable buoyancy tanks are disposed at opposite sides of the support frame and pivotally movable mounted thereto. Each side variable buoyancy tank comprises an opening disposed in a bottom portion thereof and an air conduit port disposed in a top portion thereof. A bottom air conduit system is connected to the air conduit port of each bottom variable buoyancy tank. The bottom air conduit system is adapted for controllably providing air to each bottom variable buoyancy tank and for controllably releasing air from each bottom variable buoyancy tank. A side air conduit system is connected to the air conduit port of each side variable buoyancy tank. The side air conduit system is adapted for controllably providing air to each side variable buoyancy tank and for controllably releasing air from each side variable buoyancy tank. Each bottom variable buoyancy tank and each side variable buoyancy tank comprises an elongated cylindrical wall and two end walls at a first end and a second end thereof. Each bottom variable buoyancy tank and each side variable buoyancy tank is mounted to the support frame such that a longitudinal axis thereof is oriented substantially horizontal. Each bottom variable buoyancy tank and each side variable buoyancy tank has the opening disposed in the cylindrical wall and the air conduit port is disposed in one of the end walls. The cylindrical wall of each bottom variable buoyancy tank and each side variable buoyancy tank is corrugated.

According to one aspect, there is provided a variable buoyancy platform. The variable buoyancy platform comprises a support frame with a platform floor mounted to a top thereof. A plurality of bottom variable buoyancy tanks are disposed below the support frame and mounted thereto. Each bottom variable buoyancy tank comprises an opening disposed in a bottom portion thereof and an air conduit port disposed in a top portion thereof. At least two side variable buoyancy tanks are disposed at opposite sides of the support frame and pivotally movable mounted thereto. Each side variable buoyancy tank comprises an opening disposed in a bottom portion thereof and an air conduit port disposed in a top portion thereof. A bottom air conduit system is connected to the air conduit port of each bottom variable buoyancy tank. The bottom air conduit system is adapted for controllably providing air to each bottom variable buoyancy tank and for controllably releasing air from each bottom variable buoyancy tank. A side air conduit system is connected to the air conduit port of each side variable buoyancy tank. The side air conduit system is adapted for controllably providing air to each side variable buoyancy tank and for controllably releasing air from each side variable buoyancy tank.

According to one aspect, there is provided a variable buoyancy platform. The variable buoyancy platform comprises a support frame with a platform floor mounted to a top thereof. A plurality of bottom variable buoyancy tanks are disposed below the support frame and mounted thereto. Each bottom variable buoyancy tank comprises an opening disposed in a bottom portion thereof and an air conduit port disposed in a top portion thereof. At least two side variable buoyancy tanks are disposed at opposite sides of the support frame and pivotally movable mounted thereto. Each side variable buoyancy tank comprises an opening disposed in a bottom portion thereof and an air conduit port disposed in a top portion thereof. A bottom air conduit system is connected to the air conduit port of each bottom variable buoyancy tank. The bottom air conduit system is adapted for controllably providing air to each bottom variable buoyancy tank and for controllably releasing air from each bottom variable buoyancy tank. A side air conduit system is connected to the air conduit port of each side variable buoyancy tank. The side air conduit system is adapted for controllably providing air to each side variable buoyancy tank and for controllably releasing air from each side variable buoyancy tank.

The bottom air conduit system comprises a first and a second bottom air conduit system with adjacent bottom variable buoyancy tanks being connected to the first and the second bottom air conduit system in an alternating fashion. The variable buoyancy platform further comprises a buoyancy control unit with a manifold having: the side air conduit system connected thereto via a side air system valve; the first bottom air conduit system connected thereto via a first bottom air system valve; the second bottom air conduit system connected thereto via a second bottom air system valve; an air inlet connected thereto via an air inlet valve; and, an air outlet connected thereto via an air outlet valve.

According to another aspect, there is provided a method of operating the above variable buoyancy platform. Air is provided to the side variable buoyancy tanks until water is substantially removed therefrom. Air is provided to the bottom variable buoyancy tanks until the platform is raised such that the platform floor is below a water surface in close proximity thereto.

According to another aspect, there is provided a method of operating the above variable buoyancy platform. Air is provided to the side variable buoyancy tanks until water is substantially removed therefrom. Air is provided to the bottom variable buoyancy tanks until the platform is raised such that the platform floor is below a water surface in close proximity thereto. Air is provided to the bottom variable buoyancy tanks until the platform is raised such that the platform floor is above the water surface.

According to another aspect, there is provided a method of operating the above variable buoyancy platform. Air is provided to the side variable buoyancy tanks until water is substantially removed therefrom. Air is provided to the bottom variable buoyancy tanks until the platform is raised such that the platform floor is below a water surface in close proximity thereto. Air is provided to the bottom variable buoyancy tanks until the platform is raised such that the platform floor is above the water surface. Air is released from the bottom variable buoyancy tanks until the platform is lowered such that the platform floor is below a water surface in close proximity thereto. Air is released from the bottom variable buoyancy tanks until the air is substantially removed therefrom and air is released from the side variable buoyancy tanks.

An advantage is that it provides a variable buoyancy platform that enables simple adjustment of the level of the platform floor with respect to the surrounding water level.

A further advantage is that it provides a variable buoyancy platform that enables simple adjustment of the level of the platform floor with respect to the surrounding water level such that the platform floor is above the water level and, in another mode of operation, below the water level in close proximity thereto.

A further advantage is that it provides a variable buoyancy platform that enables simple adjustment of the level of the platform floor with respect to the surrounding water level such that the platform floor is below the water level at a greater depth.

A further advantage is that it provides a variable buoyancy platform that enables lowering of the platform to a greater depth that is sufficiently fast for lowering the platform before an incoming storm.

### BRIEF DESCRIPTION OF THE DRAWINGS

An embodiment of the present invention is described below with reference to the accompanying drawings, in which:

FIG. 1 is a simplified block diagram illustrating in a top view a variable buoyancy platform according to an embodiment;

FIG. 2 is a simplified block diagram illustrating in a side view a variable buoyancy platform according to an embodiment;

FIG. 3 is a simplified block diagram illustrating in a front view a variable buoyancy platform according to an embodiment;

FIG. 4 is a simplified block diagram illustrating in a perspective top view a support frame of the variable buoyancy platform according to an embodiment;

FIG. 5 is a simplified block diagram illustrating in a perspective top view a section of the variable buoyancy platform according to an embodiment;

FIG. 6 is a simplified block diagram illustrating in a perspective bottom view a variable buoyancy tank of the variable buoyancy platform according to an embodiment;

FIG. 7 is a simplified block diagram illustrating in a perspective bottom view mounting of variable buoyancy tank of the variable buoyancy platform according to an embodiment;

FIG. 8 is a simplified block diagram illustrating in cross sectional view mounting of variable buoyancy tank of the variable buoyancy platform according to an embodiment;

FIG. 9 is a simplified block diagram illustrating in a detail perspective bottom view an air conduit system of the variable buoyancy platform according to an embodiment;

FIG. 10 is a simplified block diagram illustrating in a top view a control unit of the variable buoyancy platform according to an embodiment;

FIG. 11 is a simplified block diagram illustrating in perspective top view a box containing the control unit of the variable buoyancy platform according to an embodiment with the box being in an extended position;

FIG. 12 is a simplified block diagram illustrating in perspective top view a box containing the control unit of the variable buoyancy platform according to an embodiment with the box being in a retracted extended position;

FIG. 13A is a simplified block diagrams illustrating in cross sectional view the variable buoyancy platform in a mode of operation;

FIG. 13B is a simplified block diagrams illustrating in cross sectional view the variable buoyancy platform in a different mode of operation; and

FIG. 13C is a simplified block diagrams illustrating in cross sectional view the variable buoyancy platform in yet another different mode of operation.

### DETAILED DESCRIPTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, certain methods and materials are now described.

While the description of the embodiments hereinbelow is with reference to a variable buoyancy platform for oyster farming, it will become evident to those skilled in the art that the embodiments of the invention are not limited thereto, but are also adaptable for use with aquaculture farming of, for example, other types of shellfish such as mussels.

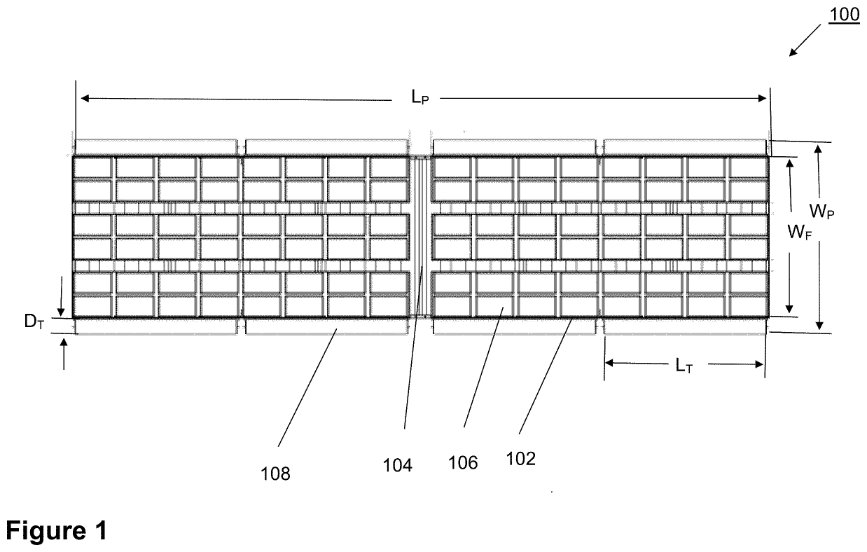

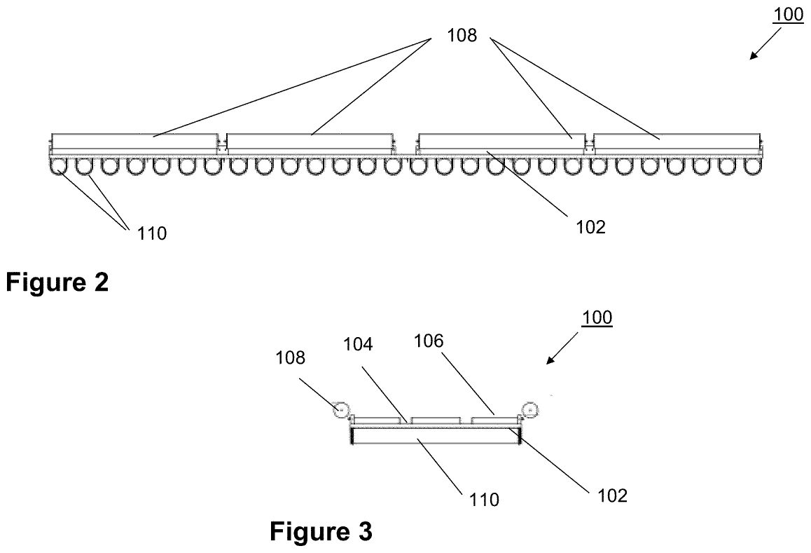

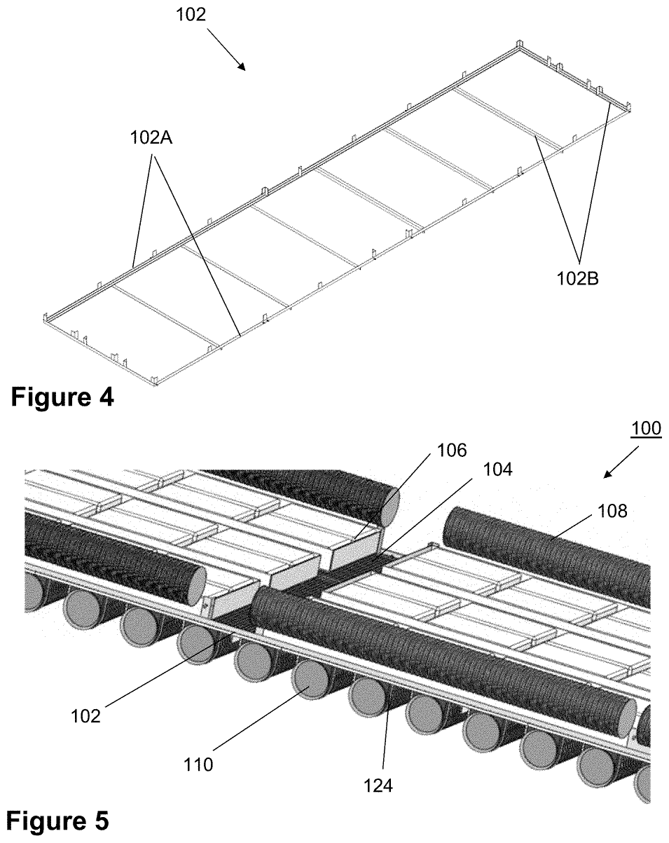

Referring to FIGS. 1 to 12 a variable buoyancy platform 100 according to an embodiment of the invention is provided. The variable buoyancy platform 100 comprises a support frame 102 having, for example, rectangular shape with two parallel beams 102A which are connected by transverse beams 102B oriented perpendicular thereto, as illustrated in FIG. 4. The support frame 102 is made of, for example, commercially available stainless steel profiles and assembled in a conventional manner using, for example, screw fastening and/or welding. Platform floor 104 is mounted to the top of the support frame 102 enabling operators to access the oyster bags disposed in cages 106. The platform floor 104 and the cages 106 are made of, for example, commercially available fiberglass sheet material with the same being assembled and mounted to the support frame 102 in a conventional manner using, for example, screw fastening and/or welding.

A plurality of bottom variable buoyancy tanks 110 is disposed below the support frame 102 and mounted thereto. Each bottom variable buoyancy tank 110 comprises an opening 116 disposed in a bottom portion thereof and an air conduit port 118 disposed in a top portion thereof. Side variable buoyancy tanks 108 are disposed at opposite sides of the support frame 102 and vertically movable mounted thereto. Each side variable buoyancy tank 108 comprises an opening 108 disposed in a bottom portion thereof and an air conduit port 118 disposed in a top portion thereof. A bottom air conduit system 128A, 128B is connected to the air conduit port 118 of each bottom variable buoyancy tank 110. The bottom air conduit system 128A, 128B is adapted for controllably providing air to each bottom variable buoyancy tank 110 and for controllably releasing air from each bottom variable buoyancy tank 110. A side air conduit system 126 is connected to the air conduit port 118 of each side variable buoyancy tank 108. The side air conduit system 126 is adapted for controllably providing air to each side variable buoyancy tank 108 and for controllably releasing air from each side variable buoyancy tank 108.

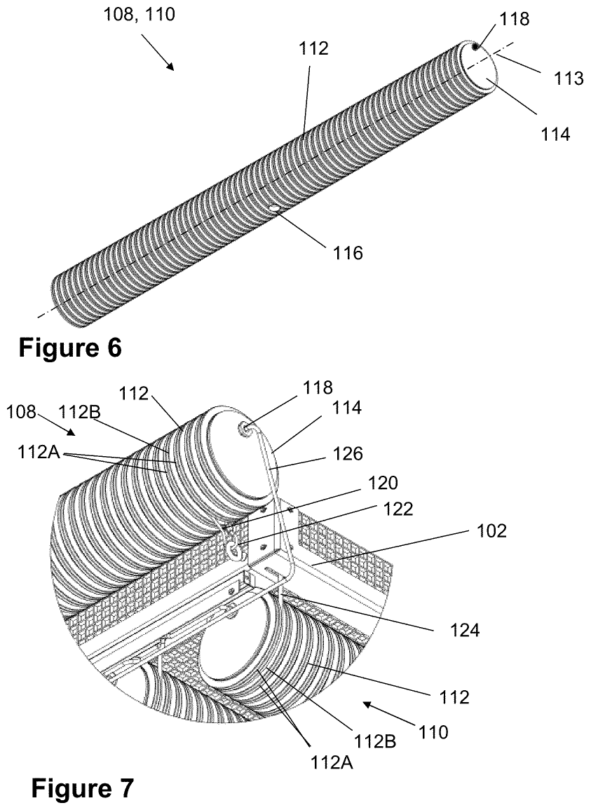

The bottom variable buoyancy tanks 110 and the side variable buoyancy tanks 108 each comprise an elongated cylindrical wall 112 and two end walls 114 mounted in a sealed fashion to the cylindrical wall 112 at a first end and a second end thereof, and are mounted to the support frame 102 such that longitudinal axis 113 is oriented substantially horizontal. Each tank 108, 110 can have the opening 116 disposed in the cylindrical wall 112 and the air conduit port 118 disposed in one of the end walls 114, as illustrated in FIG. 6. The cylindrical wall 112 can be corrugated to increase the strength of the same. The tanks 108, 110 are manufactured using, for example, commercially available plastic tubing made of PolyVinyl Chloride (PVC) or High-Density PolyEthylene (HDPE) and PVC or HDPE sheet material, and are assembled using conventional fastening such as an adhesive. Optionally, more than one opening 116 and/or port 118 are provided.

Provision of the tanks 110 with a corrugated wall 112 substantially facilitates mounting of the same to the support frame 102 using, for example, U-bolts 124 disposed in valley 112B between two adjacent ridges 112A, as illustrated in FIG. 7, with the U-bolt 124 being mounted to the support frame 102 using, for example, screw fastening, thus enabling simple removal/reinstallment of the tank 110 for repair or replacement in case of damage.

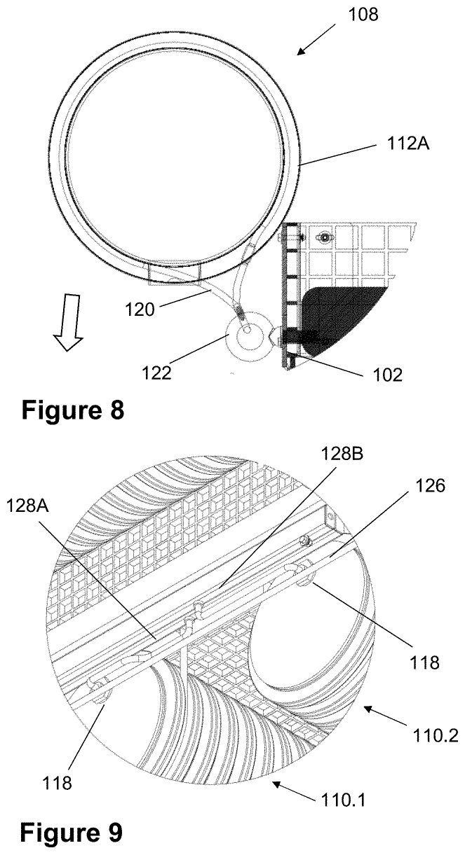

Similarly, provision of the tanks 108 with a corrugated wall 112 enables use of a ring-type structure 120 disposed in valley 112B between two adjacent ridges 112A, as illustrated in FIGS. 7 and 8, which is pivotally movable mounted to ring 122 to enable pivotal movement about the ring 122, as indicated by the block arrow in FIG. 8. The ring-type structure 120 is made of, for example, a commercially available stainless steel cable.

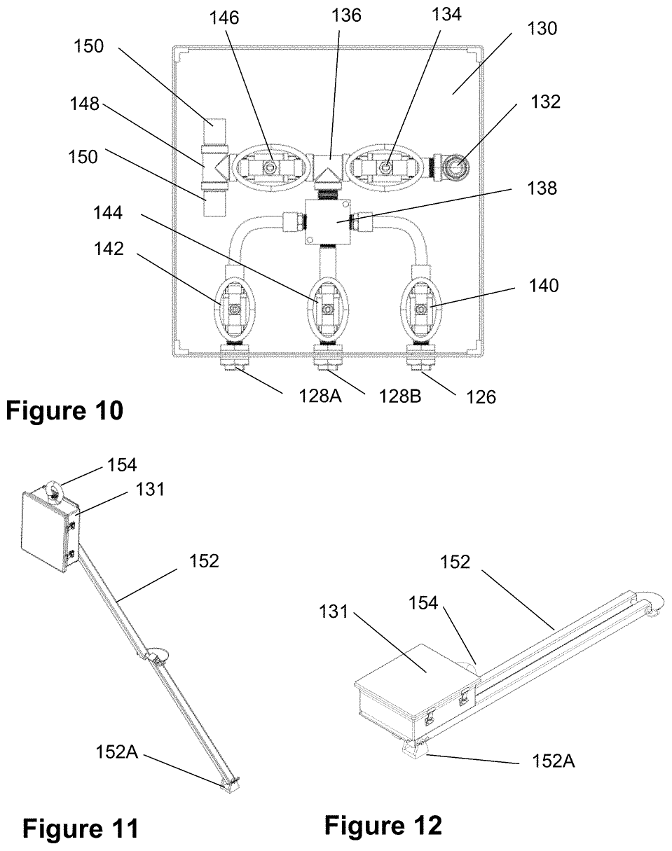

The variable buoyancy platform 100 can be operated using buoyancy control unit 130, as illustrated in FIG. 10, connected to the side air conduit system 126, and the bottom air conduit system 128A, 128B, which can comprise a first bottom air conduit system 128A and a second bottom air conduit system 128B such that adjacent bottom variable buoyancy tanks 110.1, 110.2, . . . are connected to the first bottom air conduit system 128A and the second bottom air conduit system 128B in an alternating fashion, as illustrated in FIG. 9. Provision of the two bottom air conduit systems 128A, 128B substantially facilitates rising and lowering of the platform level to the desired operating level, as well as increases the stability of the platform 100, as will be described hereinbelow.

The buoyancy control unit 130 comprises manifold 138 connected to: the side air conduit system 126 via side air system valve 140; the first bottom air conduit system 128A via first bottom air system valve 142; and, the second bottom air conduit system 128B via second bottom air system valve 144. The manifold is further connected to air inlet 132 and air outlet 148 via T-section 136. Air inlet valve 134 is interposed between the air inlet 132 and the T-section 136, while air outlet valve 146 is interposed between the air outlet 148 and the T-section 136. The air inlet 132 is, for example, a commercially available compressed air quick connect coupler for quick and simple connection to a compressed air system. Optionally, mufflers 150 are mounted to the air outlet 148 to reduce noise when air is released from the tanks 108, 110. The valves 140, 142, 144, 134, and 146 are, for example, off-the shelf manually operated shut-off valves.

The control unit 130 enables controlled provision of air to the tanks 108, 110 for rising the platform 100, as well as controlled release of air from the tanks 108, 110 for lowering the platform 100.

For rising the platform 100, the air inlet 132 is connected to a compressed air system. With the air outlet valve 146 being closed and the air inlet valve 134 being opened, the compressed air is provided to the manifold 138. By selectively opening one or more of the valves 140, 142, and 144 the operator of the platform 100 is enabled to selectively provide air to the tanks 108, 110 for rising the platform 100. Provision of compressed air displaces the water inside the tanks 108, 110, which is ejected through the opening 116 at the bottom of the tanks 108, 110, thus generating buoyancy.

For lowering the platform 100 the air inlet valve 134 is closed and the air outlet valve 146 is opened, thus enabling release of air from the manifold 138 via the air outlet 148. By selectively opening one or more of the valves 140, 142, and 144 the operator of the platform 100 is enabled to selectively release air from the tanks 108, 110 for lowering the platform 100. By releasing the air from the tanks 108, 110 the water pressure pushes water through the opening 116 into the tanks 108, 110, thus reducing buoyancy.

The control unit 130 can be contained in box 131 mounted via an extendable/retractable arm 152 to the platform 100 at base 152A. The arm 152 when extended has a length corresponding to an operating depth of the platform 100 when in the sunk position, typically between 10 feet and 30 feet. For rising the platform from the sunk position the box 131 is lifted to the surface, for example, by inserting a hook connected to a rope into ring 154 mounted to the box 131. By pulling the rope the box 131 is lifted to the surface and the arm 152 is extended. At the surface the box 131 is opened and the air inlet 132 is connected to a compressed air system for rising the platform to the surface.

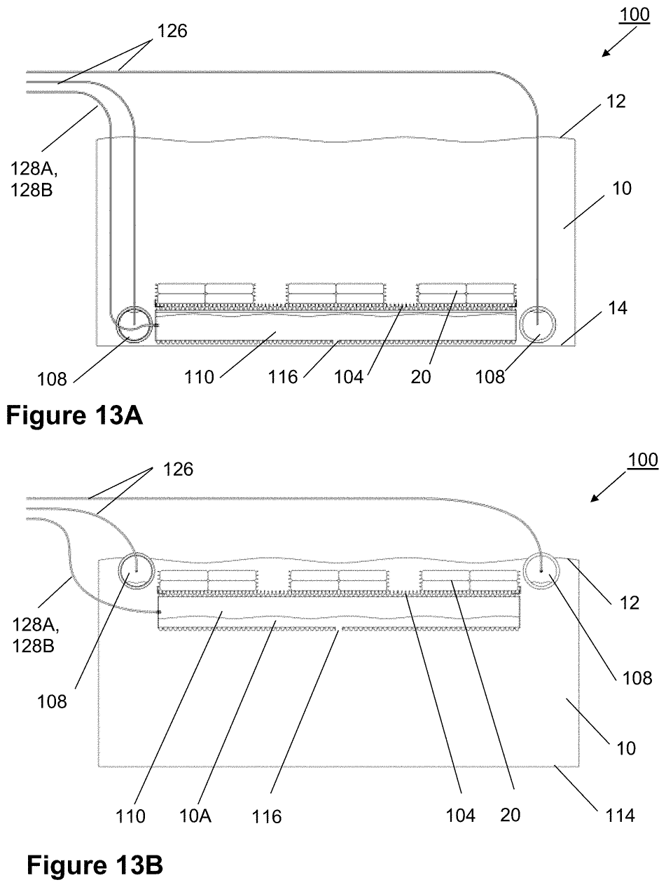

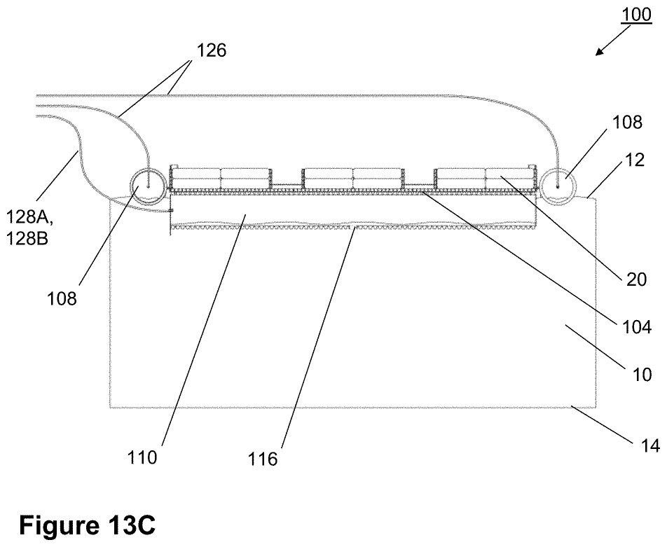

The platform 100 can be adapted for enabling three modes of operation for oyster farming illustrated in FIGS. 13A to 13C:
winter hibernation with the platform 100 in the sunk position on the seafloor 14 with the bottom variable buoyancy tanks 110 and the side variable buoyancy tanks 108 resting on the seafloor 14, as illustrated in FIG. 13A;
standard position during the growing season with the platform 100 being raised such that the platform floor 104 is below the water surface 12 in close proximity thereto, as illustrated in FIG. 13B, with the platform kept in this position for several weeks; and,
raised position during the growing season with the platform 100 being raised such that the platform floor 104 is above the water surface 12, as illustrated in FIG. 13C, with the platform kept in this position for 24 hrs to 48 hrs.

In early spring the platform 100 is raised from the sunk position by:
providing compressed air to the side variable buoyancy tanks 108 until the water 10 is substantially ejected therefrom through the opening 116, making the side variable buoyancy tanks 108 buoyant and pivotally moving the same to an upper position with respect to the platform floor 104, as illustrated in FIGS. 7 and 8;
providing air to the bottom variable buoyancy tanks 110 connected to the first bottom air conduit system 128A until the water 10 is substantially ejected therefrom through the opening 116;
providing air to the bottom variable buoyancy tanks 110 connected to the second bottom air conduit system 128B until the platform 100 starts to rise; and,
once the platform 100 is close to the standard position stabilizing the platform 100 by providing to and/or removing air from the bottom variable buoyancy tanks 110 connected to the bottom air conduit systems 128A and 128B.

In time intervals of several week during the growing season the platform 100 is raised from the standard position to the raised position to expose the oysters 20 to air and sunlight to kill fouling by:
providing air to the bottom variable buoyancy tanks 110 connected to the bottom air conduit systems 128A and 128B until the platform is fully buoyant.

After 24 hrs to 48 hrs the platform 100 is lowered from the raised position to the standard position by:
releasing air from the bottom variable buoyancy tanks 110 connected to the bottom air conduit systems 128A and 128B until the platform 100 is lowered such that the platform floor 104 is below the water surface 12 in close proximity thereto; and,
once the platform 100 is close to the standard position stabilizing the platform 100 by providing to and/or releasing air from the bottom variable buoyancy tanks 110 connected to the bottom air conduit systems 128A and 128B.

In late fall or before an incoming storm the platform 100 is lowered from the standard position to the sunk position by:
releasing air from the bottom variable buoyancy tanks 110 connected to the bottom air conduit systems 128A and 128B until all air is removed from the bottom variable buoyancy tanks 110 and water is detected at the air outlet 148; and,
releasing air from the side variable buoyancy tanks 108 until the platform 100 is in the sunk position resting on the seafloor 14.

In an example, the platform 100 has been implemented as illustrated in FIGS. 1 to 12 with the following dimensions:
platform length L_{P}=50 feet;
platform width W_{P}=14.5 feet;
support frame width W_{F}=12 feet;
tank length L_{T}=12 feet;
tank diameter D_{T}=14 inch;
number of side variable buoyancy tanks=8;
number of bottom variable buoyancy tanks=28; and,
platform load capacity=6000 lbs.

As is evident to those skilled in the art that the platform 100 may be provided in different dimensions, different shapes of the support frame 102 and the tanks 108, 110, as well as different number of tanks 108, 110, depending on design preferences.

The present invention has been described herein with regard to certain embodiments. However, it will be obvious to persons skilled in the art that a number of variations and modifications can be made without departing from the scope of the invention as described herein.

What is claimed is:

1. A variable buoyancy platform comprising:
a support frame;
a platform floor mounted to a top of the support frame;
a plurality of bottom variable buoyancy tanks disposed below the support frame and mounted thereto, each bottom variable buoyancy tank comprising an opening disposed in a bottom portion thereof and an air conduit port disposed in a top portion thereof;
at least two side variable buoyancy tanks disposed at opposite sides of the support frame and pivotally movable mounted thereto, each side variable buoyancy tank comprising an opening disposed in a bottom portion thereof and an air conduit port disposed in a top portion thereof;
a bottom air conduit system connected to the air conduit port of each bottom variable buoyancy tank, the bottom air conduit system being adapted for controllably providing air to each bottom variable buoyancy tank and for controllably releasing air from each bottom variable buoyancy tank; and,
a side air conduit system connected to the air conduit port of each side variable buoyancy tank, the side air conduit system being adapted for controllably providing air to each side variable buoyancy tank and for controllably releasing air from each side variable buoyancy tank.

2. The variable buoyancy platform according to claim 1 wherein each bottom variable buoyancy tank and each side variable buoyancy tank comprises an elongated cylindrical wall and two end walls at a first end and a second end thereof.

3. The variable buoyancy platform according to claim 2 wherein each bottom variable buoyancy tank and each side variable buoyancy tank is mounted to the support frame such that a longitudinal axis thereof is oriented substantially horizontal.

4. The variable buoyancy platform according to claim 3 wherein each bottom variable buoyancy tank and each side variable buoyancy tank has the opening disposed in the cylindrical wall and the air conduit port disposed in one of the end walls.

5. The variable buoyancy platform according to claim 4 wherein cylindrical wall of each bottom variable buoyancy tank and each side variable buoyancy tank is corrugated.

6. The variable buoyancy platform according to claim 3 wherein each bottom variable buoyancy tank is mounted to the support frame via U-bolts disposed in valleys of the cylindrical wall.

7. The variable buoyancy platform according to claim 5 wherein each side variable buoyancy tank is mounted to the support frame via a ring-type structure disposed in valleys of the cylindrical wall with the ring-type structure being pivotally movable mounted to the support frame.

8. The variable buoyancy platform according to claim 1 comprising a buoyancy control unit, the buoyancy control unit comprising a manifold having:
the side air conduit system connected thereto via a side air system valve;
the bottom air conduit system connected thereto via a bottom air system valve;
an air inlet connected thereto via an air inlet valve; and,
an air outlet connected thereto via an air outlet valve.

9. The variable buoyancy platform according to claim 8 wherein the buoyancy control unit is mounted to the support frame via an extendable/retractable arm.

10. The variable buoyancy platform according to claim 1 wherein the bottom air conduit system comprises a first and a second bottom air conduit system and wherein adjacent bottom variable buoyancy tanks are connected to the first and the second bottom air conduit system in an alternating fashion.

11. The variable buoyancy platform according to claim 10 comprising a buoyancy control unit, the buoyancy control unit comprising a manifold having:
the side air conduit system connected thereto via a side air system valve;
the first bottom air conduit system connected thereto via a first bottom air system valve;
the second bottom air conduit system connected thereto via a second bottom air system valve;
an air inlet connected thereto via an air inlet valve; and,
an air outlet connected thereto via an air outlet valve.

12. A method of operating the variable buoyancy platform according to claim 1 comprising:
providing air to the side variable buoyancy tanks until water is substantially removed therefrom; and
providing air to the bottom variable buoyancy tanks until the platform is raised such that the platform floor is below a water surface in close proximity thereto.

13. The method according to claim 12 comprising providing air to the bottom variable buoyancy tanks until the platform is raised such that the platform floor is above the water surface.

14. The method according to claim 13 comprising releasing air from the bottom variable buoyancy tanks until the platform is lowered such that the platform floor is below a water surface in close proximity thereto.

15. The method according to claim 12 comprising:
releasing air from the bottom variable buoyancy tanks until the air is substantially removed therefrom; and,
releasing air from the side variable buoyancy tanks.
